(19) United States
(12) Patent Application Publication
(10) Pub. No.: US 2013/0050522 A1
(43) Pub. Date: Feb. 28, 2013

(54) VIDEO IMAGE PROVIDING APPARATUS, VIDEO IMAGE UTILIZING APPARATUS, VIDEO IMAGE PROVIDING SYSTEM, VIDEO IMAGE PROVIDING METHOD AND RECORDING MEDIUM

(71) Applicant: Satoshi MINESHITA, Tokyo (JP)

(72) Inventor: Satoshi MINESHITA, Tokyo (JP)

(73) Assignee: NEC CORPORATION, Tokyo (JP)

(21) Appl. No.: 13/590,295

(22) Filed: Aug. 21, 2012

(30) Foreign Application Priority Data
Aug. 23, 2011 (JP) 2011-181373

(51) Int. Cl. G06K 9/46; H04N 5/228

(52) U.S. Cl. 348/222.1; 382/195; 348/E05.031

(57) ABSTRACT

The present invention has been made for purpose of providing a video image providing apparatus which can provide a variety of users with a video image captured by a surveillance camera or the like, while paying careful attention to privacy information included in the video image.

The present invention comprises: an attribute characteristic information acquisition unit which acquires attribute characteristic information representing a visual characteristic of a human attribute from an attribute characteristic information storage apparatus; a video image data acquisition unit which acquires video image data captured by an image-capturing apparatus; a human area extraction unit which extracts a human area from the video image data; an attribute determination unit which determines whether or not an area matching the attribute characteristic information is included in the human area; a human video image information transmission unit which transmits human video image information to a video image utilizing apparatus.

This application is based upon and claims the benefit of priority from Japanese Patent Application No. 2011-181373, filed on Aug. 23, 2011, the disclosure of which is incorporated herein in its entirety by reference.

### TECHNICAL FIELD

The present invention relates to a video image providing apparatus which provides other apparatuses with a video image captured by a surveillance camera or the like, a video image utilizing apparatus which utilizes a video image provided from such the video image providing apparatus, a video image providing system, a video image providing method and a recording medium.

### BACKGROUND ART

In recent years, from the aspect of security, known is an apparatus which performs processing with respect to a video image captured by a surveillance camera or the like. As such an apparatus, for example, mentioned is the one which detects a person invading into a building (for example, refer to Japanese laid-open patent publication No. 1999-41589).

Also mentioned is another one which identifies an identical person present in a plurality of images, on the basis of color information extracted from the plurality of images which are acquired by a plurality of surveillance cameras or the like (for example, refer to Japanese laid-open patent publication No. 2009-231921).

Such apparatuses are employed in a video image surveillance system which surveys a video image in which such places as in a store, inside a station and on the street, where unspecified number of people come and go, are captured.

### SUMMARY

However, it is presumed that the video image captured by the surveillance camera or the like generally involves privacy information. Accordingly, there has been a problem in that the apparatuses disclosed in Japanese laid-open patent publications No. 1999-41589 and No. 2009-231921 are available for only users who are afforded a right to use such privacy information (for example, an owner of the surveillance camera, a public institution having the right to use private information and the like).

The present invention has been made to solve the problem described above, and accordingly provides a video image providing apparatus which can provide a variety of users with such a video image, while paying careful attention to privacy information involved in a video image captured by a surveillance camera or the like.

A video image providing apparatus of the present invention includes: an attribute characteristic information acquisition unit which acquires attribute characteristic information representing a visual characteristic of a human attribute from an attribute characteristic information storage apparatus; a video image data acquisition unit which acquires video image data captured by an image-capturing apparatus;

a human area extraction unit which extracts a human area from the video image data; an attribute determination unit which determines whether or not the human area includes an area matching the attribute characteristic information; and

a human video image information transmission unit which transmits human video image information including a video image of at least a partial region of the human area, when the human area is determined to include an area matching the attribute characteristic information, to a video image utilizing apparatus which performs processing with respect to a video image of a person having the attribute.

Further, a video image utilizing apparatus of the present invention includes a human video image information acquisition unit which acquires aforementioned human video image information about a person having a predetermined attribute from the video image providing apparatus described above, and a human video image information processing unit which performs processing with respect to the human video image information.

Further, a video image providing system of the present invention includes the above-described video image providing apparatus, the above-described video image utilizing apparatus and the aforementioned attribute characteristic information storage apparatus.

Further, a video image providing method of the present invention includes: acquiring attribute characteristic information representing a visual characteristic of a human attribute from an attribute characteristic information storage apparatus;

acquiring video image data captured by an image-capturing apparatus;

extracting a human area from the video image data; determining whether or not the human area includes an area matching the attribute characteristic information; and transmitting human video image information including a video image of at least a partial region of the human area, when the human area is determined to include an area matching the attribute characteristic information, to a video image utilizing apparatus which performs processing with respect to a video image of a person having the attribute.

Further, a recording medium of the present invention stores a program to cause a computer to execute: an attribute characteristic information acquisition process to acquire attribute characteristic information representing a visual characteristic of a human attribute from an attribute characteristic information storage apparatus;

a video image data acquisition process to acquire video image data captured by an image-capturing apparatus;

a human area extraction process to extract a human area from the video image data; an attribute determination process to determine whether or not the human area includes an area matching the attribute characteristic information; and a human video image information transmission process to transmit human video image information including a video image of at least a partial region of the human area, when the human area is determined to include an area matching the attribute characteristic information, to a video image utilizing apparatus which performs processing with respect to a video image of a person having the attribute.

### BRIEF DESCRIPTION OF THE DRAWINGS

Exemplary features and advantages of the present invention will become apparent from the following detailed description when taken with the accompanying drawings in which:

FIG. 1 is a diagram showing a configuration of a video image providing system as a first exemplary embodiment of the present invention.

FIG. 2 is a diagram showing functional block configurations of respective apparatuses constituting the video image providing system as the first exemplary embodiment of the present invention.

FIG. 3 is a flow chart illustrating operation of the video image providing system as the first exemplary embodiment of the present invention.

FIG. 4 is a diagram showing a configuration of a video image providing system as a second exemplary embodiment of the present invention.

FIG. 5 is a diagram showing functional block configurations of respective apparatuses constituting the video image providing system as the second exemplary embodiment of the present invention.

FIG. 6 is a flow chart illustrating operation by which the video image providing system as the second exemplary embodiment of the present invention stores clothes characteristic information.

FIG. 7 is a flow chart illustrating operation by which the video image providing system as the second exemplary embodiment of the present invention provides comparison information.

FIG. 8 is a flow chart illustrating operation by which the video image providing system as the second exemplary embodiment of the present invention performs comparison.

FIG. 9 is a circuit block diagram of a computer of a video image providing apparatus 1 as a first exemplary embodiment or of a video image providing apparatus 10 as a second exemplary embodiment, of the present invention.

### EXEMPLARY EMBODIMENT

Hereinafter, exemplary embodiments of the present invention are described in detail with reference to drawings.

### First Exemplary Embodiment

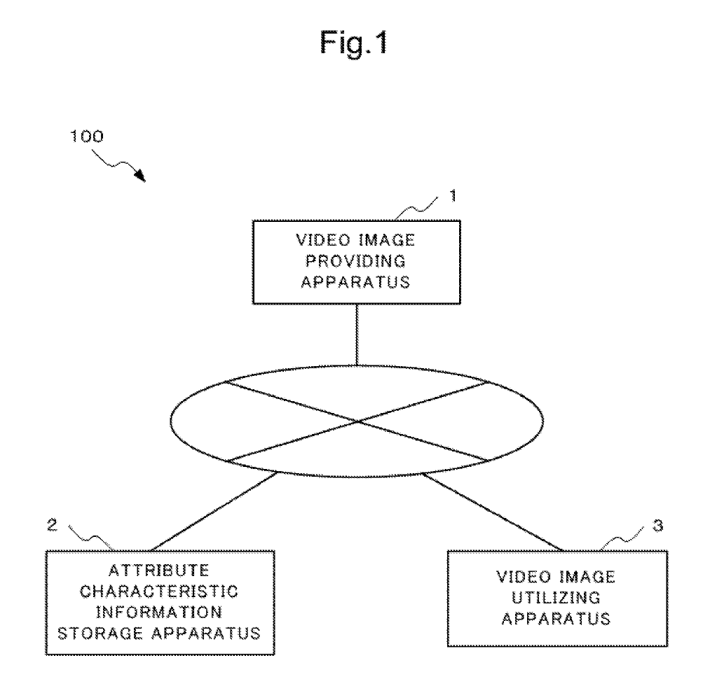

A configuration of a video image providing system 100 is shown in FIG. 1, as a first exemplary embodiment of the present invention.

In FIG. 1, the video image providing system 100 includes a video image providing apparatus 1, an attribute characteristic information storage apparatus 2 and a video image utilizing apparatus 3. The video image providing apparatus 1 is connected with the attribute characteristic information storage apparatus 2 and with the video image utilizing apparatus 3, respectively in a manner enabling them to communicate with each other, via an internet, a LAN (Local Area Network), a public line network, a wireless communication network or a network constituted by their combination.

While, in FIG. 1, the video image providing apparatus 1, the attribute characteristic information storage apparatus 2 and the video image utilizing apparatus 3 are connected to the same network, a network through which the video image providing apparatus 1 communicates with the attribute characteristic information storage apparatus 2 may be different from that through which the video image providing apparatus 1 communicates with the video image utilizing apparatus 3. Further, it is not necessarily required that the attribute characteristic information storage apparatus 2 and the video image utilizing apparatus 3 can communicate with each other.

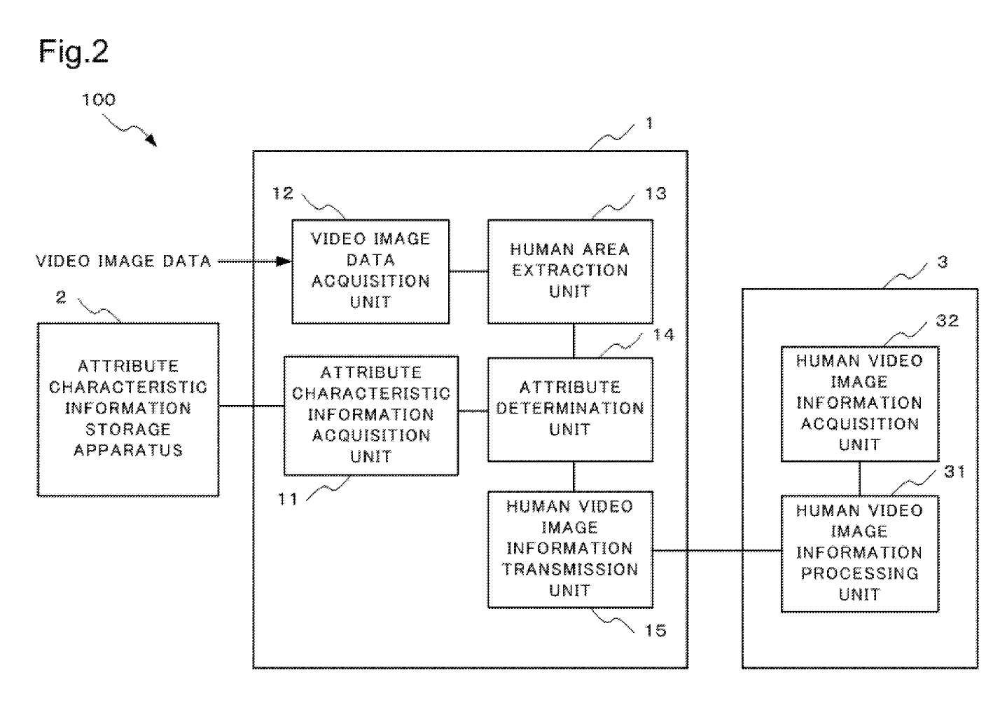

Next, functional block configurations of respective apparatuses constituting the video image providing system 100 are shown in FIG. 2.

First, a functional block configuration of the video image providing apparatus 1 is described.

In FIG. 2, the video image providing apparatus 1 includes an attribute characteristic information acquisition unit 11, a video image data acquisition unit 12, a human area extraction unit 13, an attribute determination unit 14 and a human video image information transmission unit 15.

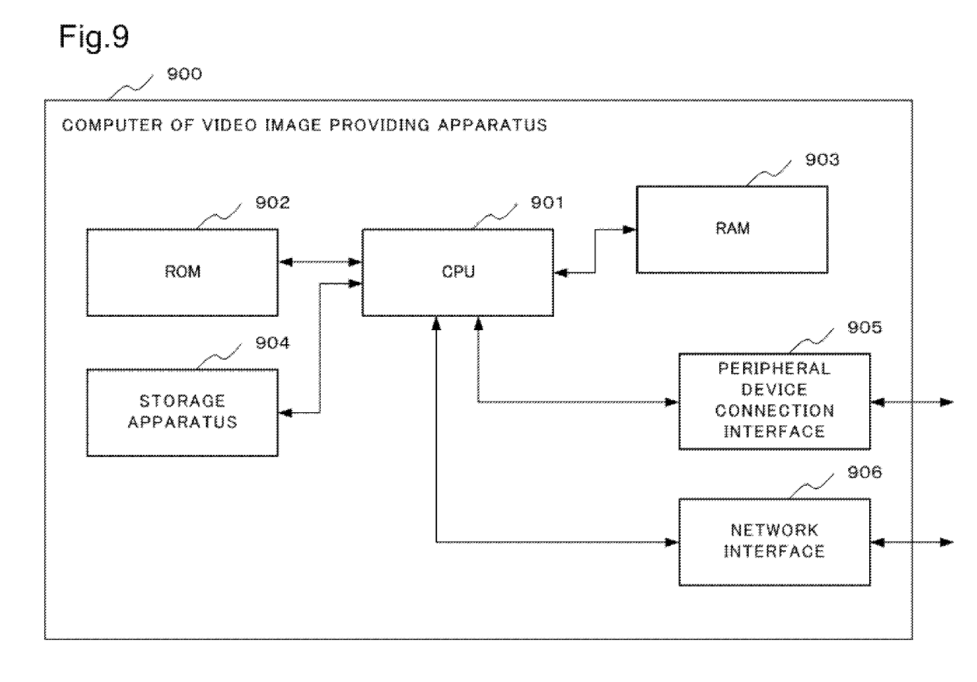

Here, as shown in FIG. 9, the video image providing apparatus 1 is constituted by a computer 900 comprising a CPU (Central Processing Unit) 901, a RAM (Random Access Memory) 903, a ROM (Read Only Memory) 902, a storage apparatus 904 such as a hard disk, a network interface 906 and a peripheral device connection interface 905, and an image-capturing apparatus.

The image-capturing apparatus may be any apparatus which acquires video image data by capturing an image of surroundings. Here, the image-capturing apparatus may be installed in the computer 900, or may be the one connected to the computer 900 from the outside via the network interface 906 or the peripheral device connection interface 905. Further, the image-capturing apparatus may be constituted by a conventional surveillance camera.

The attribute characteristic information acquisition unit 11 and the human video image information transmission unit 15 are constituted by the network interface 906 and by the CPU 901 which reads a computer program stored in the ROM 902 or the storage apparatus 904 into the RAM 903 and executes it. Further, the video image data acquisition unit 12 is constituted by the image-capturing apparatus and the CPU 901 which reads a computer program stored in the ROM 902 or the storage apparatus 904 into the RAM 903 and executes it.

Further, the human area extraction unit 13 and the attribute determination unit 14 are constituted by the CPU 901 which reads a computer program stored in the ROM 902 or the storage apparatus 904 into the RAM 903 and executes it. Here, hardware configurations making up the respective functional blocks of the video image providing apparatus 1 are not limited to the ones described above.

The attribute characteristic information acquisition unit 11 acquires attribute characteristic information representing a visual characteristic of a human attribute from the attribute characteristic information storage apparatus 2. Here, the attribute characteristic information refers to information which characterizes the human attribute and represents its visual characteristic.

For example, an attribute may be any one of a specific school, company and organization to which a person belongs, or may be two or more of them. In this case, attribute characteristic information is, for example, a school seal, an image representing an emblem of a company or an organization, color information about a uniform of a school or of a company, and information representing a shape of clothes. Further, attribute characteristic information may be image data or may be information representing a characteristic of the image data.

The video image data acquisition unit 12 acquires video image data captured by the image-capturing apparatus. The video image data may include information about a location and time of the image-capturing.

The human area extraction unit 13 extracts a human area from the video image data. A well-known technology may be employed in the processing of extracting a human area. The human area extracted by the human area extraction unit 13 is, for example, an area including a face image region and a clothed body region.

The attribute determination unit 14 determines whether or not an area matching the attribute characteristic information is included in the human area. For example, when the attribute characteristic information is image data, the attribute determination unit 14 may find a degree of similarity between the attribute characteristic information and an area which is included in the human area and is the same in size as the image of the attribute characteristic information. In this case, when the degree of similarity is equal to or larger than a threshold value, the attribute determination unit 14 may determine that the human area includes the area matching the attribute characteristic information.

Here, in this case, a well-known technology may be employed in the processing of finding a degree of similarity between images.

When the human area is determined to include the area matching the attribute characteristic information, the human video image information transmission unit 15 transmits human video image information to the video image utilizing apparatus 3. Here, the video image utilizing apparatus 3 is an apparatus which performs processing with respect to the video image of a person having the attribute.

Further, human video image information is required just to include a video image of at least a partial region of the human area. For example, human video image information may be the one including a video image of a face region or of an upper half body region, which are further detected within a human area. Further, human video image information may include, in addition to information representing such a video image, information representing the time and location of the video image acquisition.

Further, if acquiring a plurality of pieces of attribute characteristic information corresponding to a plurality of types of attributes from the attribute characteristic information storage apparatus 2, the attribute characteristic information acquisition unit 11 may acquire, in addition to attribute characteristic information corresponding to each type of attribute, further information for identifying, for each type of attribute, the video image utilizing apparatus 3 which utilizes a video image related to the person having the attribute.

In this case, the attribute determination unit 14 may determine, in terms of each type of attribute characteristic information, whether or not the human area includes the area matching the attribute characteristic information.

In that case, the human video image information transmission unit 15 detects identification information about the video image utilizing apparatus 3 related to attribute characteristic information in terms of which the human area has been determined to include the matching area with respect to one type of attribute. Then, the human video image information transmission unit 15 just may transmit human image information to the video image utilizing apparatus 3 corresponding to the identification information.

Next, functions of the attribute characteristic information storage apparatus 2 is described. The attribute characteristic information storage apparatus 2 stores attribute characteristic information such as described above. In response to a request from the video image providing apparatus 1, the attribute characteristic information storage apparatus 2 transmits attribute characteristic information to the video image providing apparatus 1. Further, the attribute characteristic information storage apparatus 2 may be configured to store information for identifying the video image utilizing apparatus 3 which utilizes the video image related to the person having the attribute, relating the information to corresponding attribute characteristic information.

Next, a functional block configuration of the video image utilizing apparatus 3 is described. In FIG. 2, the video image utilizing apparatus 3 comprises a human video image information acquisition unit 31 and a human video image information processing unit 32.

The human video image information acquisition unit 31 receives human video image information described above, which is transmitted from the video image providing apparatus 1.

The human video image information processing unit 32 performs predetermined processing on the received human video image information. For example, the human video image information processing unit 32 may perform human identification processing, by comparing human video image data included in the received human video image information with individual characteristic information stored in advance.

Here, the predetermined processing performed by the human video image information processing unit 32 is not limited to human identification processing. For example, the predetermined processing performed by the human video image information processing unit 32 may be one of collecting up a location and time of image-capturing included in the human video image information, and the like.

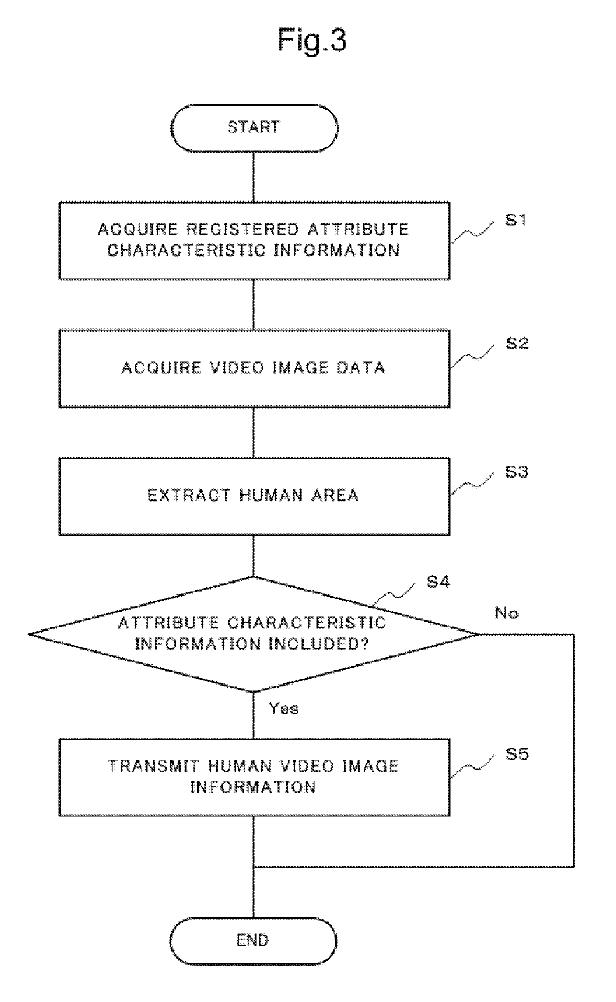

Now, the operation of the video image providing system 100 which is configured as described above, is described with reference to FIG. 3.

First, the attribute characteristic information acquisition unit 11 of the video image providing apparatus 1 transmits request information for acquiring attribute characteristic information to the attribute characteristic information storage apparatus 2, and as a reply to it, acquires attribute characteristic information from the attribute characteristic information storage apparatus 2 (Step S1). In this case, it is preferable that the attribute characteristic information acquisition unit 11 acquires attribute characteristic information corresponding to an attribute which is necessary for the user of the video image utilizing apparatus 3.

Next, the video image data acquisition unit 12 acquires video image data captured by the image-capturing apparatus (Step S2).

Then, the human area extraction unit 13 extracts the human area from the video image data acquired in Step S2 (Step S3).

Next, the attribute determination unit 14 determines whether or not the human area extracted in Step S3 includes the area matching the attribute characteristic information acquired in Step 51 (Step S4).

Here, if the human area is determined to include the area matching the attribute characteristic information, the human video image information transmission unit 15 transmits human video image information including the video image of at least a partial region of the human area to the video image utilizing apparatus 3 (Step S5), and ends the processing.

On the other hand, in Step S4, if the human area is determined not to include the area matching the attribute characteristic information, the video image providing apparatus 1 ends the processing.

The video image utilizing apparatus 3 having received the human video image information in Step S5 performs predetermined processing on the received human video image information.

With that, the description of operation of the video image providing system 100 is ended.

Next, the effect of the first exemplary embodiment of the present invention is described.

The video image providing apparatus as the first exemplary embodiment of the present invention can provide a variety of users with a video image captured by a surveillance camera or the like, while paying careful attention to privacy information included in the video image.

It is because, when the human area included in the video image includes the area matching attribute characteristic information, the attribute determination unit provides human video image information including the video image of at least a partial region of the human area to the video image utilizing apparatus which performs processing with respect to a video image of a person having the attribute. It results in that the video image providing apparatus as the first exemplary embodiment of the present invention provides information on the human area where the person having a predetermined attribute is captured, from within a video image captured by the surveillance camera or the like, to the video image utilizing apparatus which can perform processing with respect to the person having the attribute.

Therefore, the video image providing apparatus as the first exemplary embodiment of the present invention never provides information on an area including the image of the person having the attribute which the video image utilizing apparatus as being the information provision destination cannot utilize, from within a video image captured by the surveillance camera or the like.

As a result, the video image providing apparatus as the first exemplary embodiment of the present invention can provide even the video image utilizing apparatus used by a user who is not the owner of the surveillance camera nor a public institution with a video image of a region including an image of a person having an attribute, which the privacy information is allowed to be viewed at the video image utilizing apparatus, with no possibility of providing privacy information about unspecified number of people.

### Second Exemplary Embodiment

Next, a second exemplary embodiment of the present invention is described in detail with reference to drawings. Here, in the drawings referred to in describing the present exemplary embodiment, with respect to configurations or steps which are identical with or whose operation is similar to those in the first exemplary embodiment of the present invention, the same signs as in the first exemplary embodiment are given to them, and their detail descriptions are omitted in the present exemplary embodiment.

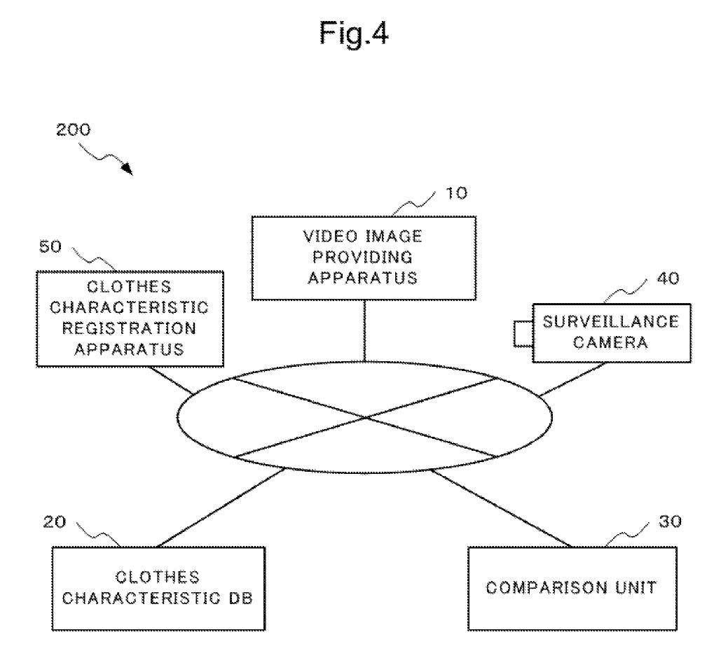

First, a configuration of a video image providing system 200 is shown in FIG. 4, as the second exemplary embodiment of the present invention. In FIG. 4, the video image providing system 200 includes a video image providing apparatus 10, a clothes characteristic information database 20 (hereafter, it will be referred to also as a clothes characteristic DB), a comparison apparatus 30, a surveillance camera 40 and a clothes characteristic registration apparatus 50. Here, the surveillance camera 40 and the clothes characteristic registration apparatus 50 may be connected to the video image providing system 200 from the outside.

The video image providing apparatus 10 is connected with the clothes characteristic DB 20 and with the comparison apparatus 30, respectively in a manner enabling them to communicate with each other, via an internet, a LAN, a public line network, a wireless communication network, or a network configured by their combination, or the like.

Here, the video image providing apparatus 10 may be connected with these apparatuses via respective networks which are different from each other.

The surveillance camera 40 is connected to the video image providing apparatus 10 directly or via a network, in a manner enabling them to communicate with each other. Further, the clothes characteristic registration apparatus 50 is connected to the clothes characteristic DB 20 via a network, in a manner enabling them to communicate with each other. The clothes characteristic DB 20 constitutes one exemplary embodiment of the attribute characteristic information storage apparatus of the present invention, and the comparison apparatus 30 constitutes one exemplary embodiment of a video image utilizing apparatus of the present invention.

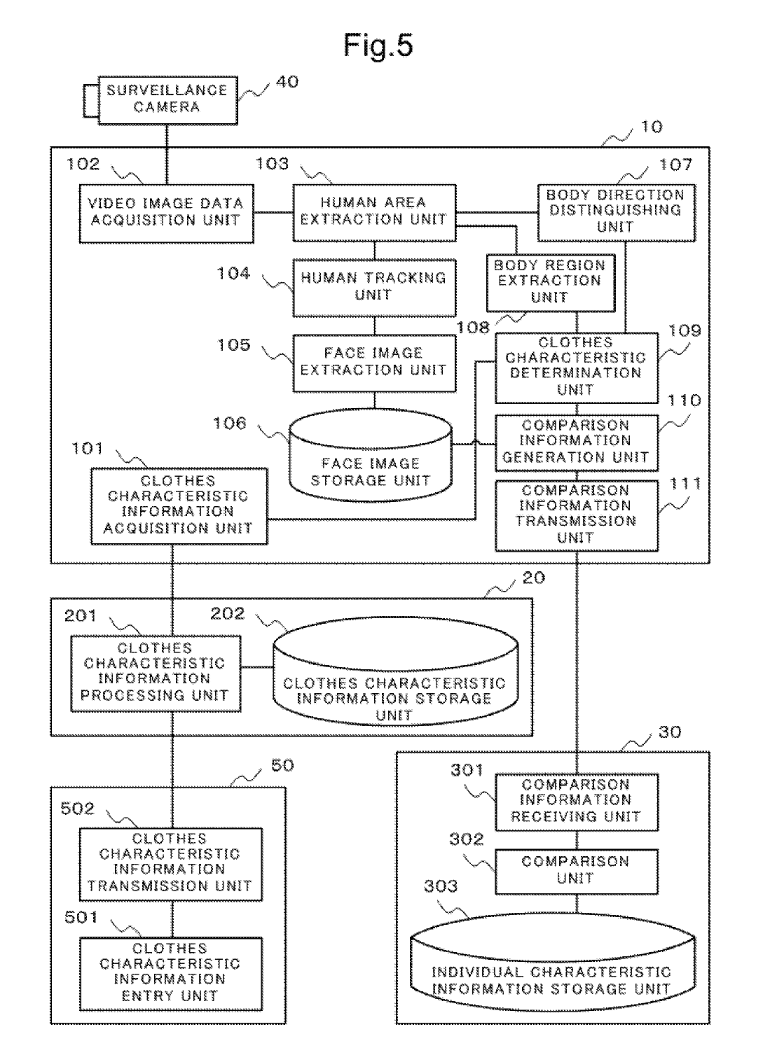

Next, the functional blocks of each apparatus constituting the video image providing system 200 is described with reference to FIG. 5.

First, functional blocks of the video image providing apparatus 10 is described.

The video image providing apparatus 10 includes a clothes characteristic information acquisition unit 101, a video image data acquisition unit 102, a human area extraction unit 103, a clothes characteristic determination unit 109, a comparison information generation unit 110 and a comparison information transmission unit 111. The video image providing apparatus 10 may further include a human tracking unit 104, a face image extraction unit 105, a face image storage unit 106, a body direction distinguishing unit 107 and body region extraction unit 108.

Here, the video image providing apparatus 10 is constituted by a computer 900 comprising components each similar to that in the video image providing apparatus 1 as the first exemplary embodiment of the present invention. Further, the clothes characteristic information acquisition unit 101 and the comparison information transmission unit 111 are constituted by a network interface 906 and a CPU 901 which reads a computer program stored in a ROM 902 and a storage apparatus 904 into a RAM 903 and executes it.

The human area extraction unit 103, the clothes characteristic determination unit 109, the comparison information generation unit 110, the human tracking unit 104, the face image extraction unit 105, the body direction distinguishing unit 107 and the body region extraction unit 108 are constituted by the CPU 901 which reads a computer program stored in the ROM 902 and the storage apparatus 904 into the RAM 903 and executes. The face image storage unit 106 is constituted by the storage apparatus. Here, hardware configurations of the respective functional blocks constituting the video image providing apparatus 10 are not limited to the ones described above.

Further, the video image providing apparatus 10 does not need necessarily to be constituted by only one computer. For example, the video image providing apparatus 10 may be constituted by a computer to perform video image analysis processing and a computer to perform various kinds of processing on information after the analysis.

In this case, the computer to perform video image analysis processing may constitute the clothes characteristic information acquisition unit 101, the video image data acquisition unit 102, the human area extraction unit 103, the clothes characteristic determination unit 109, the human tracking unit 104, the face image extraction unit 105, the body direction distinguishing unit 107 and the body region extraction unit 108. Then, the computer to perform various kinds of processing on information after the analysis may constitute the face image storage unit 106, the comparison information generation unit 110 and the comparison information transmission unit 111.

The clothes characteristic information acquisition unit 101 acquires, as attribute characteristic information, clothes characteristic information representing a clothes characteristic related to a human attribute from the clothes characteristic DB 20. Here, the clothes characteristic information may be, for example, image data in which the mark of a school seal sewn on the left chest of a uniform worn by a person belonging to a certain organization, is captured.

Further, the clothes characteristic information may be, for example, the one having undergone a treatment such as to cut out an unnecessary surroundings image region, which is performed for the purpose of making easy the matching determination processing based on such image data. Alternatively, the clothes characteristic information may be information representing the color, shape or the like of a characteristic part of such clothes.

Further, the clothes characteristic information acquisition unit 101 may acquire, along with the clothes characteristic information, information representing a body region where the clothes characteristic appears. For example, when the clothes characteristic information is image data of the mark of a school seal sewn on the left chest of a uniform, such as described above, the clothes characteristic information acquisition unit 101 may acquire information representing “left chest” along with the clothes characteristic information.

The clothes characteristic information acquisition unit 101 may also acquire, along with the clothes characteristic information, information to identify the comparison apparatus 30 which performs comparison of a person having an attribute specified by the clothes characteristic. The information to identify the comparison apparatus 30 may be, for example, an address by which the apparatus can be specified as a communication destination via a network, or the like.

Here, the clothes characteristic information acquisition unit 101 constitutes one exemplary embodiment of the attribute characteristic information acquisition unit of the present invention.

The video image data acquisition unit 102 acquires frames constituting video image data transmitted from the surveillance camera 40 in chronological order.

The human area extraction unit 103 extracts a human area where a person is captured, from each of the frames acquired by the video image data acquisition unit 102.

The human tracking unit 104 compares the human area extracted from the present frame and that from another frame, and thereby determines whether or not their human images are of an identical person. A well-known technology can be applied to the processing of determining whether or not persons respectively captured in a plurality of areas are the identical person. Here, the human tracking unit 104 may compare the human area of the present frame with that extracted from the preceding frame, and thereby determine whether or not the identical person is captured in both the frames, or it may store pieces of information representing human areas respectively extracted from a predetermined number of past frames, and thereby determine whether or not the identical person is captured in those frames.

When having determined as not the identical person, the human tracking unit 104 appends a new human ID (identification information) to the human area extracted from the present frame. On the other hand, when having determined as the identical person, the human tracking unit 104 appends to the human area extracted from the present frame the same human ID as that appended to another frame having an image of the identical person.

The face image extraction unit 105 detects a face region in the human area extracted by the human area extraction unit 103. A well-known technology can be employed in the processing to detect the face region. When the face region has been successfully detected, the face image extraction unit 105 stores a face image included in the region, relating it to a human ID appended to the human area, in the face image storage unit 106.

Here, the human area extraction unit 103, the human tracking unit 104, the face image extraction unit 105 and the face image storage unit 106 constitute one exemplary embodiment of a human area extraction unit of the present invention.

The body direction distinguishing unit 107 distinguishes the direction of the body of a person captured in the human area, by analyzing the human area. For example, the body direction distinguishing unit 107 distinguishes the direction of what angle formed from the front with respect to the surveillance camera 40, faced by the direction of the person extracted by the human area extraction unit 103. Then, the body direction distinguishing unit 107 output information about the angle, as direction information, to the clothes characteristic determination unit 109.

When the clothes characteristic information acquisition unit 101 has acquired information representing the body region where a clothes characteristic appears, the body region extraction unit 108 extracts an area including the body region from the human area extracted by the human area extraction unit 103. For example, when information representing the body region “left chest” has been acquired, it may extract an area representing the upper half body including the left chest from the human area.

The clothes characteristic determination unit 109 determines whether or not an area matching the clothes characteristic information is included in the human area. A well-known technology can be employed in this matching determination processing, similarly to in the first exemplary embodiment of the present invention. Specifically, the clothes characteristic determination unit 109 may determine whether or not the area matching the clothes characteristic information is included in an area where a corresponding body region is extracted by the body region extraction unit 108,

When the body direction has been distinguished by the body direction distinguishing unit 107, the clothes characteristic determination unit 109 may perform the matching determination processing in terms of the clothes characteristic information after normalizing the human area to make the body direction face in a predetermined direction. For example, when the body direction has been determined to face in the right anterior oblique direction with respect to the surveillance camera 40, the clothes characteristic determination unit 109 performs image processing to normalize the human area to make the body face the front of the surveillance camera 40.

Then, the clothes characteristic determination unit 109 may determine whether or not an area matching the clothes characteristic information is included in the human area after the normalization. Alternatively, the clothes characteristic determination unit 109 may perform such normalization processing on an area of a body region extracted by the body region extraction unit 108.

Here, the body direction distinguishing unit 107, the body region extraction unit 108 and the clothes characteristic determination unit 109 constitute one exemplary embodiment of an attribute determination unit of the present invention.

When the clothes characteristic determination unit 109 has determined that the area matching the clothes characteristic information is included in the human area, the comparison information generation unit 110 generates human video image information including the face image included in the human area.

Specifically, the comparison information generation unit 110 acquires the face image related to the human ID appended to the human area from the face image storage unit 106.

Then, the comparison information generation unit 110 generates comparison information including the acquired face image and related information. The related information may be, for example, the acquisition date and time, the image-capturing location, the surveillance camera identification information, the human ID or the like, of the present frame.

The comparison information transmission unit 111 transmits the comparison information to the comparison apparatus 30. Similarly to in the first exemplary embodiment of the present invention, when a plurality of pieces of clothes characteristic information have been acquired by the clothes characteristic information acquisition unit 101, the comparison information transmission unit 111 transmits comparison information to a comparison apparatus 30 related to a piece of clothes characteristic information in terms of which the clothes characteristic determination unit 109 determines that an area matching it is included in the human area.

Here, the comparison information generation unit 110 and the comparison information transmission unit 111 constitute one exemplary embodiment of a human image information transmission unit of the present invention.

Next, the functional blocks of the clothes characteristic DB 20 is described.

In FIG. 5, the clothes characteristic DB 20 comprises a clothes characteristic information processing unit 201 and a clothes characteristic information storage unit 202.

Here, the clothes characteristic DB 20 is constituted by a general-purpose computer comprising at least a CPU, a RAM, a ROM, a storage apparatus and a network interface. The clothes characteristic information processing unit 201 is constituted by a network interface and a CPU which reads a computer program stored in the ROM or the storage apparatus into the RAM and execute it. The clothes characteristic information storage unit 202 is constituted by the storage apparatus 202. Here, hardware configurations of the respective functional blocks making up the clothes characteristic DB 20 are not limited to the ones described above.

The clothes characteristic information processing unit 201 receives clothes characteristic information from an external apparatus such as a clothes characteristic registration apparatus 50, and stores it in the clothes characteristic information storage unit 202. At that time, the clothes characteristic information processing unit 201 may apply a processing treatment to the received clothes characteristic information before storing it in the clothes characteristic information storage unit 202.

The processing treatment may be, for example, when an image in which a school seal is captured has been received, image processing such as to sharpen contours in the image in which a school seal is captured, and to eliminate shadows in the image. Further, when having acquired, along with clothes characteristic information, information representing a body region where the characteristic appears, the clothes characteristic information processing unit 201 may store the clothes characteristic information and the information representing the body region, relating them to each other, in the clothes characteristic information storage unit 202.

Further, when having received, along with clothes characteristic information, identification information about the comparison apparatus 30 which performs comparison of a person having an attribute specified by the clothes characteristic, the clothes characteristic information processing unit 201 may store the clothes characteristic information and the identification information about the comparison apparatus 30, relating them to each other, in the clothes characteristic information storage unit 202.

When receiving a request for clothes characteristic information from the video image providing apparatus 10, the clothes characteristic information processing unit 201 transmits the clothes characteristic information stored in the clothes characteristic information storage unit 202 to the video image providing apparatus 10. At that time, if there is information related to the clothes characteristic information, the clothes characteristic information processing unit 201 transmits also the related information.

The clothes characteristic information storage unit 202 stores at least clothes characteristic information. The clothes characteristic information storage unit 202 may further store information representing the body region and identification information about the comparison apparatus 30 which performs comparison of the person having the attribute specified by the clothes characteristic, relating them to the clothes characteristic information.

Next, the functional blocks of the clothes characteristic registration apparatus 50 is described.

In FIG. 5, the clothes characteristic registration apparatus 50 comprises a clothes characteristic information entry unit 501 and a clothes characteristic information transmission unit 502.

Here, the clothes characteristic registration apparatus 50 is constituted by a general-purpose computer comprising a CPU, a RAM, a ROM, a storage apparatus, an input device, a display device, a network interface and a camera. The clothes characteristic information entry unit 501 is constituted by the camera, the input device and the display device.

The clothes characteristic information transmission unit 502 is constituted by a network interface and a CPU which reads a computer program stored in the ROM or the storage apparatus into the RAM and executes it. Here, hardware configurations of the respective functional blocks making up the clothes characteristic registration apparatus 50 are not limited to the ones described above.

The clothes characteristic information entry unit 501 acquires clothes characteristic information representing a characteristic of clothes. For example, the clothes characteristic information entry unit 501 may acquire an image in which a region of a school seal sewn on the left chest of a uniform is captured by the camera, as clothes characteristic information. Alternatively, the clothes characteristic information entry unit 501 may acquire an image file stored in the storage apparatus in advance, as clothes characteristic information.

The clothes characteristic information entry unit 501 may further acquire information to identify the comparison apparatus 30 which performs comparison of the person having the attribute specified by the clothes characteristic. Also, the clothes characteristic information entry unit 501 may further acquire information representing a body region where the clothes characteristic appears.

The clothes characteristic information transmission unit 502 transmits clothes characteristic information acquired by the clothes characteristic information entry unit 501 to the clothes characteristic DB 20. When the clothes characteristic information entry unit 501 has acquired information to identify the related comparison apparatus 30 and information representing the body region, the clothes characteristic information transmission unit 502 transmits also those pieces of information to the clothes characteristic DB 20.

Next, the functional blocks of the comparison apparatus 30 is described.

In FIG. 5, the comparison apparatus 30 comprises a comparison information receiving unit 301, a comparison unit 302 and an individual characteristic information storage unit 303. Here, the comparison apparatus 30 is constituted by a general-purpose computer comprising a CPU, a RAM, a ROM, a storage apparatus and a network interface. The comparison information receiving unit 301 is constituted by a network interface and a CPU which reads a computer program stored in the ROM or the storage apparatus into the RAM and execute it.

The comparison unit 302 is constituted by the CPU which reads into the RAM and executes a computer program stored in the ROM or the storage apparatus. The individual characteristic information storage unit 303 is constituted by the storage apparatus. Here, hardware configurations of the respective functional blocks making up the comparison apparatus 30 is not limited to the ones described above.

The comparison information receiving unit 301 receives comparison information from the video image providing apparatus 10. Here, the comparison information receiving unit 301 constitutes one exemplary embodiment of a human image information acquisition unit of the present invention.

The individual characteristic information storage unit 303 stores individual characteristic information for individual human identification of a person captured in a video image. In the present exemplary embodiment, the individual characteristic information is assumed to be information representing a characteristic of a face image. Further, individual characteristic information stored in the individual characteristic information storage unit 303 is individual characteristic information about the person having the attribute in terms of which the comparison apparatus 30 can make comparison.

By comparing the face image included in the received comparison information with individual characteristic information stored in the individual characteristic information storage unit 303, the comparison unit 302 performs processing for individual human identification of the face image included in the comparison information. The comparison unit 302 constitutes one exemplary embodiment of a human image information processing unit of the present invention.

Now, the operation of the video image providing system 200 configured as above is described with reference to drawings.

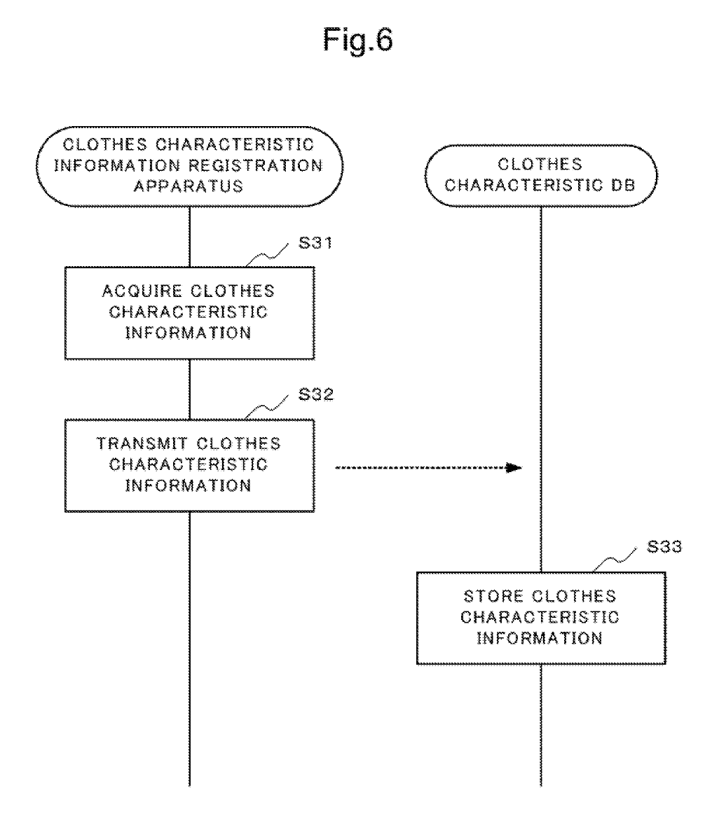

First, the operation for storing clothes characteristic information performed by the video image providing system 200 is described with reference to FIG. 6. In FIG. 6, it is assumed that a flow on the left side illustrates operation of the clothes characteristic registration apparatus 50, and a flow on the right side illustrates operation of the clothes characteristic DB 20.

First, the clothes characteristic information entry unit 501 of the clothes characteristic registration apparatus 50 acquires clothes characteristic information (Step S31). For example, as described above, the clothes characteristic information entry unit 501 may acquire clothes characteristic information via the camera or from the storage apparatus. Also as described above, the clothes characteristic information entry unit 501 may acquire, along with the clothes characteristic information, information to identify a comparison apparatus 30 and information representing a body region.

Next, the clothes characteristic information transmission unit 502 transmits the clothes characteristic information acquired in Step S31 to the clothes characteristic DB 20 (Step S32). At that time, if information to identify the comparison apparatus 30 related to the clothes characteristic information and information representing a body region have been acquired in Step S31, as described above, the clothes characteristic information transmission unit 502 transmits also those pieces of information to the clothes characteristic DB 20.

Next, the clothes characteristic information processing unit 201 of the clothes characteristic DB 20 having received the clothes characteristic information stores the received clothes characteristic information in the clothes characteristic information storage unit 202 (Step S33). At that time, as described above, the clothes characteristic information processing unit 201 may perform a processing treatment on the received clothes characteristic information before storing it to the clothes characteristic information storage unit 202.

Further, when information representing a body region where the characteristic appears and identification information about the related comparison apparatus 30 have been received along with the clothes characteristic information, as described above, the clothes characteristic information processing unit 201 just may store the clothes characteristic information and those pieces of information, relating them to each other, in the clothes characteristic information storage unit 202.

With that, the description of clothes characteristic information storing operation of the video image providing system 200 is ended.

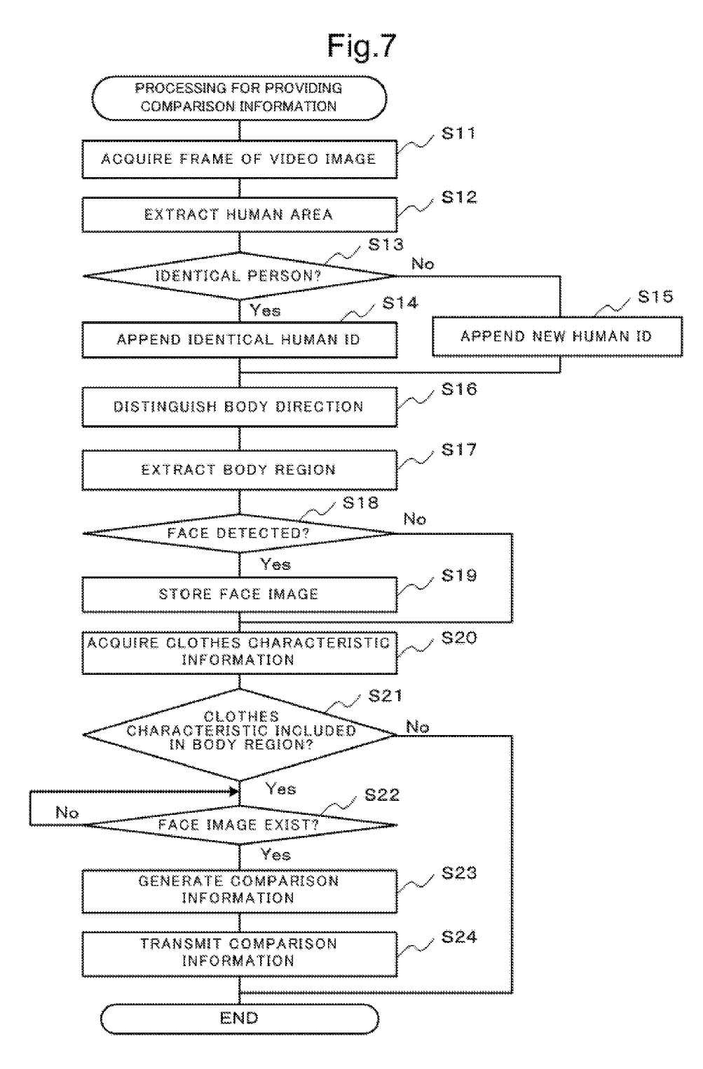

Next, the operation by which the video image providing apparatus 10 provides the comparison apparatus 30 with a video image acquired from the surveillance camera 40 is described with reference to FIG. 7.

In this operation, first, the video image data acquisition unit 102 of the video image providing apparatus 10 acquires one frame of captured video image data from the surveillance camera 40 (Step S11).

Next, the human area extraction unit 103 extracts a human area from the image of the frame acquired in Step Sll (Step S12).

Next, by comparing a human area extracted in the preceding Step S12 from a frame acquired in the preceding Step Sll and the human area extracted in the present Step S12, the human tracking unit 104 determines whether or not persons respectively captured in these human areas are an identical person (Step S13).

Here, if they are determined as an identical person, the human tracking unit 104 assigns the same human ID as that of the previous frame to the human area extracted in the present Step S12 (Step S14).

On the other hand, if they are determined as not an identical person in Step S13, the human tracking unit 104 assigns a new human ID to the human area extracted in the present Step S12 (Step S15). Here, also when a human area was not extracted in the preceding Step S12, the human tracking unit 104 assigns a new human ID to the presently extracted human area.

Next, the body direction distinguishing unit 107 distinguishes the body direction of a person captured in the extracted human area (Step S16).

Then, the body region extraction unit 108 extracts areas representing respective body regions from the extracted human area. For example, the body region extraction unit 108 may extract areas representing respectively a head region, an upper half body region and a lower half body region, from the human area (Step S17).

Next, the face image extraction unit 105 determines whether or not detection of a face image is possible in the area representing a head region (Step S18).

Here, if a face image can be detected, the face image extraction unit 105 stores the detected face image and the human ID, relating them to each other, in the face image storage unit 106 (Step S19).

Next, the clothes characteristic information acquisition unit 101 acquires clothes characteristic information registered in the clothes characteristic DB 20 (Step S20). Here, the clothes characteristic information acquisition unit 101 may execute this step in parallel with Steps S11-S19 or in advance before executing Step S11.

Next, the clothes characteristic determination unit 109 compares the areas representing respective body regions extracted in Step S17 and the clothes characteristic information acquired from the clothes characteristic DB 20. Specifically, on the basis of information representing a body region which is related to the clothes characteristic information acquired from the clothes characteristic DB 20, the clothes characteristic determination unit 109 determines whether or not an area matching the clothes characteristic information is included in the area including the body region (Step S21).

At that time, the clothes characteristic determination unit 109 may normalize the area into a predetermined body direction (for example, the front direction), on the basis of the body direction distinguished by the body direction distinguishing unit 107, before carrying out the determination. For example, when information representing “left chest” is related to the clothes characteristic information and the body direction has been distinguished as facing to the right in Step S16, the clothes characteristic determination unit 109 just may normalize the area representing an upper half body region into the front direction and subsequently to determine whether or not an area matching the clothes characteristic information is included in the normalized area.

Further, when a plurality of pieces of clothes characteristic information have been acquired from the clothes characteristic DB 20, the clothes characteristic determination unit 109 may execute the processing of Step S21 in terms of each of the pieces of clothes characteristic information, and may end the processing of Step S21 at a time when it determines that an area matching any one of the pieces of clothes characteristic information is included.

Here, when an area matching the clothes characteristic information registered in the clothes characteristic DB 20 is included in the human area (Yes at Step S21), the comparison information generation unit 110 acquires a face image related to the human ID assigned to this human area from the face image storage unit 106 (Yes at Step S22).

If no face image of the human ID is registered in the face image storage unit 106 (No at Step S22), the comparison information generation unit 110 stands by until a face image corresponding to the human ID is registered in the processing from Step Sll on subsequent frames acquired from the surveillance camera 40.

Next, the comparison information generation unit 110 generates comparison information including the face image acquired in Step S22 and related information (information on such as the capturing time and location of the present frame) (Step S23).

Then, the comparison information transmission unit 111 transmits the generated comparison information to the comparison apparatus 30 (Step S24). With that step, the video image providing apparatus 10 completes operation of providing the comparison apparatus 30 with a video image.

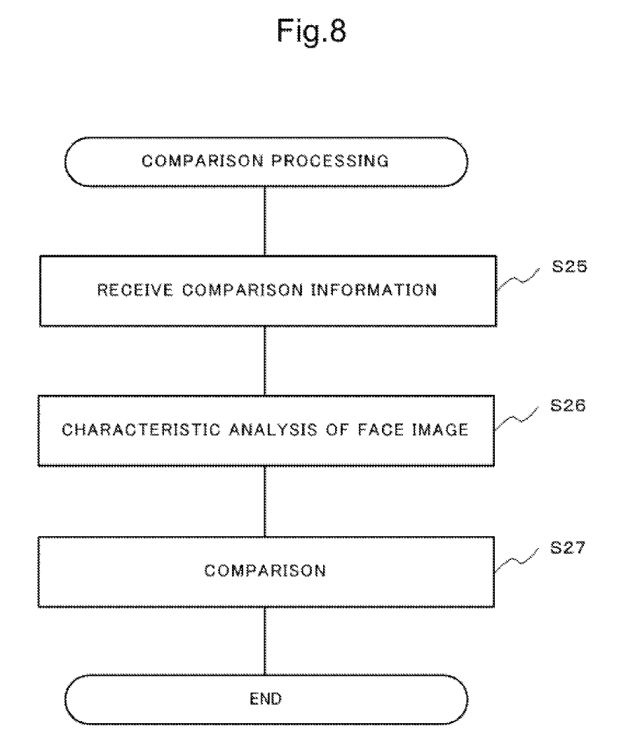

Next, the operation of the comparison apparatus 30 having received the comparison information is described with reference to FIG. 8.

In FIG. 8, the comparison information receiving unit 301 of the comparison apparatus 30 receives the comparison information (Step S25).

Next, the comparison unit 302 analyzes a characteristic of the face image included in the comparison information (Step S26).

Then, the comparison unit 302 compares the characteristic of the face image included in the comparison information with individual characteristic information stored in the individual characteristic information storage unit 303 (Step S27). By this way, if individual characteristic information matching the characteristic of the face image included in the comparison information exists in the individual characteristic information storage unit 303, it results in that the comparison unit 302 specifies human identification information of this face image.

With that, the description of human comparison operation of the video image providing system 200 is ended.

Next, the effect of the second exemplary embodiment of the present invention is described.

The video image providing system as the second exemplary embodiment of the present invention can provide information for identical human comparison to a comparison apparatus which can view privacy information about a person captured by a surveillance camera.

It is because the clothes characteristic DB registers clothes characteristic information representing a characteristic of clothes capable of specifying a human attribute in advance, and the video image providing apparatus determines whether or not an area matching the registered clothes characteristic information is included in a human area in a video image captured by a surveillance camera, and when included, it provides comparison information including a face image included in the human area to a comparison apparatus which can perform comparison of a person having the attribute specified by the clothes characteristic information.

As a result, the video image providing system as the second exemplary embodiment of the present invention enables utilization of a video image captured by the surveillance camera installed at a place such as on the street and in a store, where unspecified number of people come and go, at a variety of comparison apparatuses, while paying careful attention to privacy information.

That is, in the video image providing system as the second exemplary embodiment of the present invention, a user who wants to utilize a video image of a surveillance camera registers attribute characteristic information representing a visual characteristic of an attribute of a person for whom the user's viewing privacy information is regarded to cause no problem, in the attribute characteristic DB in advance through the attribute characteristic information registration apparatus.

As a result, it becomes possible for such a user to receive a face image and related information of a person matching the attribute characteristic information into a comparison apparatus and use them for individual human identification. On the one hand, such the user receives nothing about a video image (privacy information) of the person not matching the attribute characteristic information, among persons captured in a video image of the surveillance camera, into the comparison apparatus. In this way, it becomes possible for the video image providing system as the second exemplary embodiment of the present invention to provide a variety of comparison apparatuses with a video image of a surveillance camera, while paying careful attention to privacy information.

Although, in the present exemplary embodiment, description has been given of an example where comparison information includes a face image detected in human video image information, information included in comparison information is not limited only to a face image. For example, in comparison information, an image of a whole human area or that of an upper half body region may be included.

Further, in the present exemplary embodiment, description has been given assuming that clothes characteristic information is information representing a characteristic of clothes, but as long as it is information representing a visual characteristic of a human attribute, clothes characteristic information does not necessarily needs to be a characteristic of clothes. For example, clothes characteristic information may be an image of a bag stipulated by an organization a person belongs to, an image of an ID card with a logo hanging around a person's neck, and the like.

Further, in each exemplary embodiment of the present invention described above, it is possible to configure the system such that the operation of the video image providing apparatus described with reference to the corresponding flow chart is stored as a computer program of the present invention in a storage apparatus (recording medium) of a computer, and a corresponding CPU reads and executes the program. In such cases, the present invention is constituted by the recording medium storing codes of the program.

As shown in FIG. 9, it is possible to configure the system such that a CPU reads a computer program stored in a ROM or a storage apparatus into a RAM and executes it, and thereby each operation step of the video image providing apparatus is performed.

Further, the exemplary embodiments described above can be embodied in an combination with each other appropriately.

Furthermore, the present invention is not limited to the exemplary embodiments described above, and can be embodied in a variety of aspects.

A part or whole of the exemplary embodiments described above can be described as the following further exemplary embodiments, but is not limited to the following ones.

### Further Exemplary Embodiment 1

A video image providing apparatus comprising:

an attribute characteristic information acquisition unit which acquires attribute characteristic information representing a visual characteristic of a human attribute from an attribute characteristic information storage apparatus;

a video image data acquisition unit which acquires video image data captured by an image-capturing apparatus;

a human area extraction unit which extracts a human area from said video image data;

an attribute determination unit which determines whether or not an area matching said attribute characteristic information is included in said human area; and

a human video image information transmission unit which transmits human video image information including an video image of at least a partial region of said human area to a video image utilizing apparatus which performs processing with respect to a video image of a person having said human attribute, when said human area is determined to include an area matching said attribute characteristic information.

### Further Exemplary Embodiment 2

The video image providing apparatus according to further exemplary embodiment 1, wherein

said attribute characteristic information acquisition unit acquires, as said attribute characteristic information, clothes characteristic information representing a characteristic of clothes related to said human attribute.

### Further Exemplary Embodiment 3

The video image providing apparatus according to further exemplary embodiments 1 or 2, wherein

said human video image information transmission unit transmits a face image included in said human area by including at least it in said human video image information.

### Further Exemplary Embodiment 4

The video image providing apparatus according to any one of further exemplary embodiments 1 to 3, wherein

said attribute determination unit determines whether or not an area matching said attribute characteristic information is included in said human area which is normalized, by distinguishing the direction of a body in said human area, such that the body faces in a predetermined direction.

### Further Exemplary Embodiment 5

The video image providing apparatus according to any one of further exemplary embodiments 1 to 4, wherein:

said attribute characteristic information acquisition unit further acquires information representing a body region related to said attribute characteristic information, in addition to said attribute characteristic information; and

said attribute determination unit extracts an area of said body region from said human area, and determines whether or not an area matching said attribute characteristic information is included in the extracted area.

### Further Exemplary Embodiment 6

The video image providing apparatus according to any one of further exemplary embodiments 1 to 5, wherein,

when said video image data acquisition unit acquires a plurality of frames constituting said video image data in accordance with their chronological order:

said human area extraction unit appends a human ID to a human area extracted from one of the frames, by determining whether or not the human area represents the same person as that in a human area extracted from another frame; and,

when said human area is determined to include an area matching said attribute characteristic information, said human video image information transmission unit transmits said human video image information to said video image utilizing apparatus, on the basis of at least one of the human area of the corresponding frame and a human area of another frame to which the same human ID is appended.

### Further Exemplary Embodiment 7

The video image providing apparatus according to further exemplary embodiment 6, wherein,

when said human area is determined to include an area matching said attribute characteristic information, and a face image cannot be detected in the human area of the corresponding frame, said human video image information transmission unit transmits said human video image information including at least a face image detected in a human area of another frame to which the same human ID is appended, to said video image utilizing apparatus.

### Further Exemplary Embodiment 8

A video image utilizing apparatus comprising:

a human video image information acquisition unit which acquires said human video image information about a person having a predetermined attribute from the video image providing apparatus according to any one of further exemplary embodiments 1 to 7; and

a human image information processing unit which performs processing with respect to said human video image information.

### Further Exemplary Embodiment 9

The video image utilizing apparatus according to further exemplary embodiment 8, further comprising an individual characteristic information storage unit which stores individual characteristic information representing a visual characteristic of a person having said predetermined attribute, for the purpose of individual identification of the person, wherein

said human video image information processing unit compares said human video image information and said individual characteristic information.

### Further Exemplary Embodiment 10

A video image providing system comprising:

the video image providing apparatus according to any one of further exemplary embodiments 1 to 7;

the video image utilizing apparatus according to further exemplary embodiments 8 or 9; and

said attribute characteristic information storage apparatus.

### Further Exemplary Embodiment 11

A video image providing method comprising:

acquiring attribute characteristic information representing a visual characteristic of a human attribute from an attribute characteristic information storage apparatus;

acquiring video image data captured by an image-capturing apparatus; extracting a human area from said video image data;

determining whether or not an area matching said attribute characteristic information is included in said human area; and

transmitting human video image information including an video image of at least a partial region of said human area to a video image utilizing apparatus which performs processing with respect to an video image of a person having said attribute, when said human area is determined to include an area matching said attribute characteristic information.

### Further Exemplary Embodiment 12

A non-transitory computer-readable medium storing a program to cause a computer to execute:

an attribute characteristic information acquisition process to acquire attribute characteristic information representing a visual characteristic of a human attribute from an attribute characteristic information storage apparatus;

a video image data acquisition process to acquire video image data captured by an image-capturing apparatus;

a human area extraction process to extract a human area from said video image data;

an attribute determination process to determine whether or not an area matching said attribute characteristic information is included in said human area; and

a human video image information transmission process to transmit human video image information including an video image of at least a partial region of said human area to a video image utilizing apparatus which performs processing with respect to an video image of a person having said attribute, when said human area is determined to include an area matching said attribute characteristic information.

What is claimed is:

1. A video image providing apparatus comprising:
an attribute characteristic information acquisition unit which acquires attribute characteristic information representing a visual characteristic of a human attribute from an attribute characteristic information storage apparatus;
a video image data acquisition unit which acquires video image data captured by an image-capturing apparatus;
a human area extraction unit which extracts a human area from the video image data;
an attribute determination unit which determines whether or not an area matching the attribute characteristic information is included in the human area; and
a human video image information transmission unit which transmits human video image information including an video image of at least a partial region of the human area to a video image utilizing apparatus which performs processing with respect to a video image of a person having the human attribute, when the human area is determined to include the area matching the attribute characteristic information.

2. The video image providing apparatus according to claim 1, wherein
the attribute characteristic information acquisition unit acquires, as the attribute characteristic information, clothes characteristic information representing a characteristic of clothes related to the human attribute.

3. The video image providing apparatus according to claim 1, wherein
the human video image information transmission unit transmits a face image included in the human area, by including at least it in the human video image information.

4. The video image providing apparatus according to claim 1, wherein:
the attribute characteristic information acquisition unit further acquires information representing a body region related to the attribute characteristic information, in addition to the attribute characteristic information; and
the attribute determination unit extracts an area of the body region from the human area, and determines whether or not an area matching the attribute characteristic information is included in the extracted area.

5. The video image providing apparatus according to claim 1, wherein,
when the video image data acquisition unit acquires a plurality of frames constituting the video image data in accordance with their chronological order:
the human area extraction unit appends a human ID to a human area extracted from one of the frames, by determining whether or not the human area represents the same person as that in a human area extracted from another frame; and,
when the human area is determined to include an area matching the attribute characteristic information, the human video image information transmission unit transmits the human video image information to the video image utilizing apparatus, on the basis of at least one of the human area of the corresponding frame and a human area of another frame to which the same human ID is appended.

6. A video image utilizing apparatus comprising:
a human video image information acquisition unit which acquires the human video image information about a person having a predetermined attribute from the video image providing apparatus according to any one of claims 1; and
a human video image information processing unit which performs processing with respect to the human image information.

7. The video image utilizing apparatus according to claim 6, further comprising an individual characteristic information storage unit which stores individual characteristic information representing a visual characteristic of a person having the predetermined attribute, for the purpose of individual identification of the person, wherein
the human video image information processing unit compares the human video image information and the individual characteristic information.

8. A video image providing system comprising:
the video image providing apparatus according to claim 1;
the video image utilizing apparatus according to claim 6; and
the attribute characteristic information storage apparatus.

9. A video image providing method comprising:
acquiring attribute characteristic information representing a visual characteristic of a human attribute from an attribute characteristic information storage apparatus;
acquiring video image data captured by an image-capturing apparatus;
extracting a human area from the video image data;
determining whether or not an area matching the attribute characteristic information is included in the human area; and
transmitting human video image information including an video image of at least a partial region of the human area to a video image utilizing apparatus which performs processing with respect to an video image of a person having the attribute, when the human area is determined to include an area matching the attribute characteristic information.

10. A non-transitory computer-readable medium storing a program to cause a computer to execute:
an attribute characteristic information acquisition process to acquire attribute characteristic information representing a visual characteristic of a human attribute from an attribute characteristic information storage apparatus;
a video image data acquisition process to acquire video image data captured by an image-capturing apparatus;
a human area extraction process to extract a human area from the video image data;
an attribute determination process to determine whether or not an area matching the attribute characteristic information is included in the human area; and
a human video image information transmission process to transmit human video image information including an video image of at least a partial region of the human area to a video image utilizing apparatus which performs processing with respect to an video image of a person having the attribute, when the human area is determined to include an area matching the attribute characteristic information.
